(19) United States
(12) Patent Application Publication
(10) Pub. No.: US 2005/0140102 A1
(43) Pub. Date: Jun. 30, 2005

(54) Work apparatus

(76) Inventors: Pasquale A. Trello, Sewickley, PA (US); Irene D. Hoelen-Trello, Sewickley, PA (US)

Correspondence Address: THE WEBB LAW FIRM, P.C., 700 KOPPERS BUILDING, 436 SEVENTH AVENUE, PITTSBURGH, PA, 15219, US

(21) Appl. No.: 10/939,980

(22) Filed: Sep. 13, 2004

Related U.S. Application Data
(60) Provisional application No. 60/502,736, filed on Sep. 12, 2003.

(51) Int. Cl. B62B 11/00

(52) U.S. Cl. 280/32.6

(57) ABSTRACT

A work apparatus including a platform element with an upper surface and a lower surface. The upper surface of the platform element includes a plurality of indented portions that are capable of at least partially receiving a user's knees. In one preferred and non-limiting embodiment, the work apparatus includes at least one and typically multiple roller elements positioned on the lower surface of the platform element. These roller elements allow the platform element to move across a substantially horizontal surface, such as the ground, a floor and the like.

### CROSS-REFERENCE TO RELATED APPLICATION

This application claims the benefit of U.S. Provisional Application No. 60/502,736 filed Sep. 12, 2003, entitled “Movable Work Apparatus”.

### BACKGROUND OF THE INVENTION

1. Field of the Invention

The present invention relates generally to apparatus, implements and tools for use in connection with activities, cleaning, construction, and home improvement of a floor or other ground area and, in particular, to a work apparatus that is portable and allows a user to comfortably kneel and engage in the activity on the floor or ground surface.

2. Description of Related Art

In the field of construction, home improvement, gardening, cleaning and similar activities, one must typically kneel down in order to accomplish or engage in such activities on a ground or floor surface. For example, if a person wishes to clean the floor of their house, and in order to get the maximum pressure against the floor, therefore yielding the best desired cleaning effect, it is often preferable to kneel down and use one's hands together with a cleaning implement. Similarly, in the area of construction and home improvement, in order to lay tile, hardwood, linoleum, etc. on a base substrate, again, the craftsman must kneel down and move along the floor on his or her hands and knees to create the floor layer. Still further, various outdoor activities, such as weeding, washing the car and other related activities also require a person engaged in an activity to kneel down on the ground surface.

There are obvious drawbacks to engaging in these activities. First, the constant standing, shuffling and kneeling process is detrimental to a person's physique and health. In addition, it is uncomfortable to kneel for long periods of time and crawl or otherwise traverse the floor or ground. Even when using long pants, kneepads or the like, the continual impact and pressure on a person's knees is unhealthy. Yet another drawback to simply using a padded surface, knee pads or other similar pliant material is the need to continually move the pad, which, in any case, requires the user to stand or crouch, move the pad and reposition themselves on the pad for additional work. This is both monotonous and hard on the user's body.

### SUMMARY OF THE INVENTION

It is, therefore, an object of the present invention to provide a work apparatus that overcomes the deficiencies of the prior art. It is another object of the present invention to provide a work apparatus that provides support to a user's knees when engaged in a kneeling activity. It is yet another object of the present invention to provide a work apparatus that allows a user to traverse or move along a floor or ground surface without the need to stand and reposition. It is a still further object of the present invention to provide a work apparatus that aids in protecting a user's health and body.

The present invention is a work apparatus. The work apparatus includes a platform element with an upper surface and a lower surface. The upper surface of the platform element includes a plurality of indented portions that are capable of at least partially receiving a user's knees. In one preferred and non-limiting embodiment, the work apparatus includes at least one and typically multiple roller elements positioned on the lower surface of the platform element. These roller elements allow the platform element to move across a substantially horizontal surface, such as the ground, a floor and the like.

In a preferred and non-limiting embodiment, two spaced indented portions are positioned in a substantially central area of the platform element. Each spaced indented portion is sized and shaped so as to accept a user's knee therein. In order to add further comfort, a pliable layer may be positioned on a portion of the upper surface of the platform element and in a preferred and non-limiting embodiment, within the indented portions of the platform element. This pliable layer may be foam material, fabric, synthetic material, polymer, rubber, neoprene, elastomeric material, etc.

In yet another preferred and non-limiting embodiment, the lower surface of the platform element includes a first, second, third and fourth peripheral area. A roller element is positioned in and extends from each of the four peripheral areas. The roller elements, which may be casters, wheels or the like, allow the user to motivate or push the platform element around the horizontal surface.

The present invention, both as to its construction and its method of operation, together with the additional objects and advantages thereof, will best be understood from the following description of exemplary embodiments when read in connection with the accompanying drawings.

### BRIEF DESCRIPTION OF THE DRAWINGS

FIG. 1 is a top view of a preferred embodiment of a work apparatus according to the present invention;

FIG. 2 is a bottom view of the work apparatus of FIG. 1;

FIG. 3 is a side and partial sectional view of a further preferred embodiment of a work apparatus according to the present invention;

FIG. 4 is a bottom view of a still further preferred embodiment of a work apparatus according to the present invention;

FIG. 5 is a bottom view of a still further preferred embodiment of a work apparatus according to the present invention.

FIG. 6 is a side view of another preferred embodiment of a work apparatus according to the present invention;

FIG. 7 is a top view of yet another preferred embodiment of a work apparatus according to the present invention;

FIG. 8 is a side view of a further preferred embodiment of a work apparatus according to the present invention;

FIG. 9 is a top view of a still further preferred embodiment of a work apparatus according to the present invention; and

FIG. 10 is a side view of a still further preferred embodiment of a work apparatus according to the present invention.

### DETAILED DESCRIPTION OF THE INVENTION

For purposes of the description hereinafter, the terms “upper”, “lower”, “right”, “left”, “vertical”, “horizontal”, “top”, “bottom” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

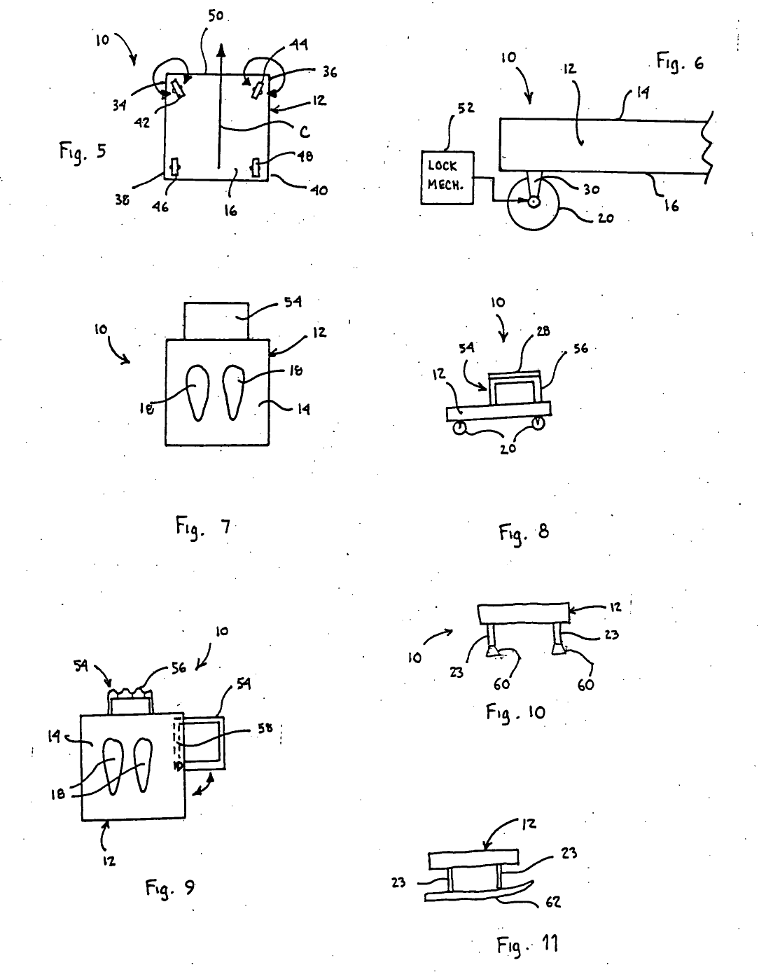

The present invention is a work apparatus 10 and is illustrated in several preferred and non-limiting embodiments in FIGS. 1-10. The work apparatus 10 includes a platform element 12, and the platform element 12 has an upper surface 14 and a lower surface 16. The upper surface 14 of the platform element 12 includes a plurality of indented portions 18, and these indented portions 18 are sized and shaped such that they may at least partially receive a user's knees therein. Therefore, a person may comfortably kneel by placing a knee in each of the indented portions 18, which are formed to at least partially conform to the shape of a person's knees. In addition, the shape of the indented portions 18 provides improved support for the user's knees, promotes better posture and increases the user's comfort.

In one preferred and non-limiting embodiment, the work apparatus 10 also includes at least one, and typically multiple roller elements 20 that are positioned on the lower surface 16 of the platform element 12, extending therefrom toward a substantially horizontal surface 22, such as a floor, the ground, etc. These roller elements 20 allow the platform element 12 to move across the horizontal surface 22. However, in the place of the roller elements 20, simple legs 23, supports or similar elements may be used to support the platform element 12 in a spaced relationship with the ground surface. Still further, the roller elements 20 may be positioned on the end of one or more of the legs 23.

As seen in FIG. 1, in one preferred and non-limiting embodiment, the platform element 12 is a substantially square-shaped structure, and the indented portions 18 are shaped to comfortably receive the user's knees therein. Accordingly, as seen in FIGS. 1 and 3, the indented portions 18 are narrow and shallow at a first end 24 of the indented portion 18, and gradually widen and deepen, terminating at a second end 26 of the indented portion 18. In this embodiment, there are two indented portions 18, and these indented portions 18 are spaced and positioned in a substantially central area of the platform area 12. The spacing and positioning constitute design choices that maximize comfort for the user's body and knee structure. In addition, the spacing may be chosen based upon a normal or average adult body size and shape or other similar criteria.

As seen in FIGS. 2 and 3, in another preferred and non-limiting embodiment, multiple roller elements 20 are used. Specifically, in the embodiments shown and described herein, four roller elements 20 are used. These roller elements 20 can be casters (as shown in FIG. 2) or wheels (as shown, for example, in FIGS. 3-5). In order to increase the comfort when a user is in a kneeling position and using the work apparatus 10, a pliable layer 28 is positioned on at least a portion of the upper surface 14 of the platform element 12. As shown in the embodiment of FIG. 3, the pliable layer 28 is preferably positioned within the indented portions 18 of the upper surface 14 of the platform element 12. As this is the area on which the user places his or her knees, the pliable layer 28 is particularly useful in providing added comfort during a working application. It is envisioned that the pliable layer 28 may be a foam material, a fabric, a synthetic material, a polymer, rubber, neoprene, elastomeric material, etc. It is further envisioned that the pliable layer 28 may be any padded layer that would achieve a similar effect.

The platform element 12 can be manufactured from various materials. For example, the platform element 12 may be manufactured from a synthetic material, a plastic, a polymer, polypropylene, etc. Further, it is envisioned that, in a preferred method of manufacture, the platform element 12 is cast molded in a substantially square shape.

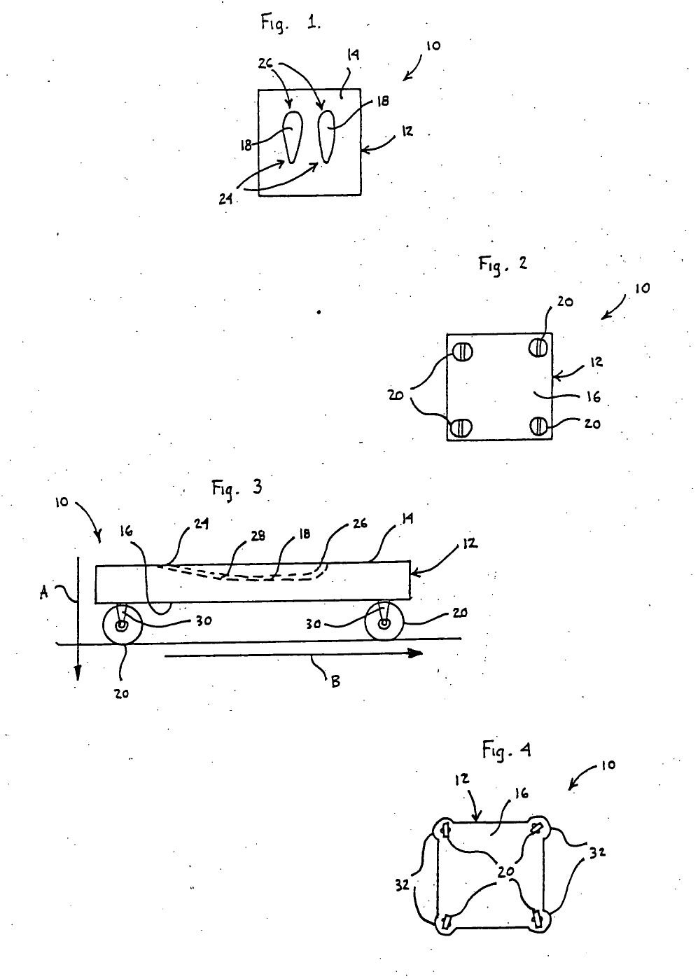

In order to attach the roller elements 20 to the lower surface 16 of the platform element 12, an attachment mechanism 30 is utilized. Any attachment mechanism 30, as is known in the art of attaching wheels to a platform, is envisioned. In another preferred and non-limiting embodiment, as illustrated in FIG. 4, the substantially square platform element 12 may include hub projections 32 extending from a corner area of the platform area 12. This lends to the aesthetic quality and structural integrity of the platform element 12 when a user kneels thereon.

As discussed above, in a preferred and non-limiting embodiment, the platform element 12 is a substantially square-shaped structure, and the lower surface 16 of the platform element 12 includes a first peripheral area 34, a second peripheral area 36, a third peripheral area 38 and a fourth peripheral area 40. In this embodiment, a first roller element 42 is positioned in and extends from the first peripheral area 34. A second roller element 44 is positioned in and extends from the second peripheral area 36, and a third roller element 46 is positioned in and extends from the third peripheral area 38. Finally, a fourth roller element 48 is positioned in and extends from the fourth peripheral area 40. In this embodiment, one, and typically multiple, of the first roller element 42, the second roller element 44, the third roller element 46 and the fourth roller element 48 are configured to rotate about axis A, which is transverse to a plane of movement B. Similarly, one, and typically multiple, of the first roller element 42, the second roller element 44, the third roller element 46 and the fourth roller element 48 are fixed and configured to roll in a fixed axis of movement C. This fixed axis of movement C typically intersects a front edge 50 of the platform element 12. In this manner, when the work apparatus 10 is moved, it moves in the forward plane of movement B.

In another preferred embodiment, the first roller element 42 and the second roller element 44 are configured to rotate about the axis A that is transverse to the plane of movement B. In addition, it is the third roller element 46 and the fourth roller element 48 that are configured to roll in the fixed axis of movement C. This resulting structure allows a user to steer the platform element 12 left and right and move the work apparatus 10 to a desired position on the horizontal surface 22.

Once the user has moved the work apparatus 10 to a desired position, it may often be preferable to hold the work apparatus 10 in place. Therefore, in another preferred embodiment, a lock mechanism 52 is used in connection with one or more of the first roller element 42, second roller element 44, third roller element 46 and fourth roller element 48. The lock mechanism 52 may be hand actuated and is of a construction as is known in the art. Once the user has placed the work apparatus 10 in the desired location, he or she may simply lock the roller elements 20 and begin work without the possibility of the platform element 12 sliding away as the user is engaged in the working process.

In yet another preferred and non-limiting embodiment, a support portion 54 is in operative communication with the platform element 12. The support portion 54 provides a support area to the user. In addition, in this embodiment, the support portion 54 extends from an edge of the platform element 12. The support portion 54 may extend vertically or horizontally from the platform element 12. As seen in the embodiment of FIG. 7, the support portion extends horizontally from an edge of the platform element 12. In the embodiment of FIG. 8, the support portion is a handle 56, which extends vertically from the platform element 12. Such a handle 56 would allow the user to grasp the handle 56 for support during work or to guide the platform element 12 while motivating the work apparatus 10 to another position on the horizontal surface 22. The support portion 54 may also be a tray, a secondary platform, etc. When the support portion 54 is a tray, the user may place cleaning supplies, objects, tools, etc. on the support portion 54, such that these materials are available to the user while kneeling on the work apparatus 10.

It is further envisioned that the support portion 54 may be movable, retractable or adjustable with respect to the platform element 12. In the preferred and non-limiting embodiment of FIG. 9, the support portion 54, and specifically an edge portion 58 of the support portion 54 is hingedly connected to the lower surface 16 of the platform element 12. In operation, the support portion 54 can be positioned under the platform element 12 in a non-use position, and swung away from and extend from the platform element 12 in a use position. This lends to the compact and expandable functionality of the work apparatus 10.

As with the indented portions 18, the pliable layer 28 may also be positioned on one or more surfaces of the support portion 54. In this manner, as seen in the embodiment of FIG. 9, a pliable grip can be placed on the support portion 54 for assisting in a comfortable grasping function during the work process. It is further envisioned that the support portion 54 may be formed as an integral piece with the platform element 12 during the manufacturing process. However, any one or more of the platform element 12, the roller elements 20 and the support portion 54 may be detachable and attachable by the consumer.

As illustrated in FIG. 10, the work apparatus 10 is usable in areas and activities that do not require or are not amenable to the user of the roller elements 20. Accordingly, the aforementioned legs 23 can be used to support the platform element 12 in a spaced relationship with respect to the ground surface. In addition, one or more feet 56 can be positioned at the base of each leg 23 to provide additional padding functionality or better support. However, it is also envisioned that the roller elements 20 may positioned or positionable in place of one or more of the feet 56, such that the work apparatus 10 is both spaced from the ground and movable thereon. Still further, when used in an outdoor location, it may preferable to use roller elements 20 that include the appropriate tires, support structures or even shocks.

In this manner, a work apparatus 10 is provided that overcomes the deficiencies of the prior art. The work apparatus 10 allows a user to comfortably kneel on the platform element 12 to accomplish an activity. Further, in one preferred embodiment, the work apparatus 10 is easily motivated around the horizontal surface 22 and does not require the user to continually stand and readjust his or her position. Overall, the work apparatus 10 allows a user to more healthily engage in construction, home improvement, cleaning, etc. on a ground or floor surface.

This invention has been described with reference to the preferred embodiments. Obvious modifications and alterations will occur to others upon reading and understanding the preceding detailed description. It is intended that the invention be construed as including all such modifications and alterations.

1. A work apparatus, comprising a platform element having an upper surface and a lower surface, the upper surface of the platform element including a plurality of indented portions configured to at least partially receive a user's knees.

2. The work apparatus of claim 1, wherein two spaced indented portions are positioned in a substantially central area of the platform element.

3. The work apparatus of claim 1, further comprising a pliable layer positioned on at least a portion of the upper surface of the platform element.

4. The work apparatus of claim 3, wherein the pliable layer is one of a foam material, fabric, a synthetic material, a polymer, rubber, neoprene and an elastomeric material.

5. The work apparatus of claim 3, wherein the pliable layer is positioned at least partially within the indented portions of the upper surface of the platform element.

6. The work apparatus of claim 1, wherein the platform element is manufactured from at least one of a synthetic material, a plastic, a polymer and polypropylene.

7. The work apparatus of claim 6, wherein the platform element is cast molded in a substantially square shape.

8. The work apparatus of claim 1, further comprising at least one roller element positioned on the lower surface of the platform element and configured to allow the platform element to move across a substantially horizontal surface.

9. The work apparatus of claim 1, further comprising at least one leg positioned on and extending from the lower surface of the platform element and configured to support the platform element in a spaced relationship with a ground surface.

10. The work apparatus of claim 9, further comprising at least one of a roller element, a foot and a ski-like element positioned on a distal end of at least one leg.

11. The work apparatus of claim 1, wherein the lower surface of the platform element includes at least a first peripheral area, a second peripheral area, a third peripheral area and a fourth peripheral area, wherein a first roller element is positioned in and extends from the first peripheral area, a second roller element is positioned in and extends from the second peripheral area, a third roller element is positioned in and extends from the third peripheral area, and a fourth roller element is positioned in and extends from the fourth peripheral area.

12. The work apparatus of claim 11, wherein at least one of the first roller element, the second roller element, the third roller element and the fourth roller element are configured to rotate about an axis transverse to a plane of movement.

13. The work apparatus of claim 11, wherein at least one of the first roller element, the second roller element, the third roller element and the fourth roller element are fixed and configured to roll in a fixed axis of movement.

14. The work apparatus of claim 13, wherein the fixed axis of movement intersects a front edge of the platform element.

15. The work apparatus of claim 11, wherein the first roller element and the second roller element are configured to rotate about an axis transverse to a plane of movement, and the third roller element and the fourth roller element are configured to roll in a fixed axis of movement.

16. The work apparatus of claim 1, wherein the at least one roller element includes a lock mechanism configured to prevent the roller element from moving.

17. The work apparatus of claim 1, further comprising at least one support portion in operative communication with the platform element and configured to provide a support area to the user.

18. The work apparatus of claim 17, wherein the support portion extends substantially from an edge of the platform element in at least one of a vertical and a horizontal direction.

19. The work apparatus of claim 17, wherein the support portion is at least one of a handle, a tray and a secondary platform.

20. The work apparatus of claim 17, wherein the support portion is at least one of movable, retractable and adjustable with respect to the platform element.

21. The work apparatus of claim 20, wherein at least one edge portion of the support portion is hingedly connected to the lower surface of the platform element, such that the support portion can be positioned under the platform element in a non-use position and extending from the platform element in a use position.

22. The work apparatus of claim 17, wherein the support portion further includes a pliable layer positioned on at least a portion of a surface of the support portion.

23. The work apparatus of claim 22, wherein the pliable layer is one of a foam material, fabric, a synthetic material, a polymer, rubber, neoprene and an elastomeric material.
